(19) United States
(12) Patent Application Publication
(10) Pub. No.: US 2013/0327654 A1
(43) Pub. Date: Dec. 12, 2013

(54) METHOD AND APPARATUS FOR A PHOTOCATALYTIC AND ELECTROCATALYTIC COPOLYMER

(71) Applicant: Viceroy Chemical, Fall River, MA (US)

(72) Inventors: Tara Cronin, New York, NY (US); Ed Ite Chen, New York, NY (US)

(21) Appl. No.: 13/837,372

(22) Filed: Mar. 15, 2013

Related U.S. Application Data
(60) Provisional application No. 61/657,975, filed on Jun. 11, 2012.
(60) Provisional application No. 61/696,608, filed on Sep. 4, 2012.

(51) Int. Cl. B01J 31/10; C25B 3/00; C25B 15/08

(52) U.S. Cl. CPC B01J 31/10; C25B 15/08; C25B 3/00
USPC 205/437; 521/27; 502/159; 502/62; 204/277; 205/413; 205/462

(57) ABSTRACT

A method and apparatus for a photocatalytic and electrolytic catalyst includes in various aspects one or more catalysts, a method for forming a catalyst, an electrolytic cell, and a reaction method.

The priority of U.S. Application Ser. No. 61/657,975, entitled, “Catalytic Membrane for the Continuous Air Capture and Simultaneous Fixation of C02”, filed Jun. 11, 2012, in the name of the inventors Tara Cronin and Ed Chen is hereby claimed pursuant to 35 U.S.C. §119(e). This application is commonly assigned herewith and is also hereby incorporated for ail purposes as if set forth verbatim herein.

The priority of U.S. Application Ser. No. 61/696,608, entitled, “Protein and Enzyme Cofactors Immobilized Nafion or Other Electroconducting Polymer Co-membrane”, filed Sep. 8, 2012, in the name of the inventors Tarn Cronin and Ed Chen is hereby claimed pursuant to 35 U.S.C. §119(e). This application is commonly assigned herewith and is also hereby incorporated for all purposes as if set forth verbatim herein.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This section of this document introduces information about and/or from the art that may provide context for or be related to the subject matter described herein and/or claimed below. It provides background information to facilitate a better understanding of the various aspects of the claimed subject matter. This is therefore a discussion of “related” art. That such art is related in no way implies that it is also “prior” art. The related art may or may not be prior art. The discussion in this section of this document is to be read in this light, and not as admissions of prior art.

Some common industrial processes involve the conversion of a gas or components of a gaseous mixture into another gas. These types of processes are performed at high pressures and temperatures. Operational considerations such as temperature and pressure requirements frequently make these types of processes energy inefficient and costly. The industries in which these processes are used therefore spend a great deal of effort in improving the processes with respect to these kinds of considerations. The art, however, is always receptive to improvements or alternative means, methods and configurations. Therefore the art will well receive the technique described herein.

### SUMMARY

In a first aspect, a catalyst comprises: a first component selected from protein enzymes, metabolic factors, organometallic compounds and combinations thereof; and a second component bonded to the first component, wherein the second component is selected from fluorinated sulfonic acid based polymers, polyaniline and combinations thereof.

In a second aspect, a method of forming a catalyst comprising: contacting a first component selected from selected from protein enzymes, metabolic factors, organometallic compounds and combinations thereof with a second component selected from fluorinated sulfonic acid based polymers, polyaniline and combinations thereof.

In a third aspect, an electrolytic cell, comprises: at least one reaction chamber into which, during operation, an aqueous electrolyte and a gaseous feedstock are introduced, wherein the gaseous feedstock comprises a carbon-based gas; and a pair of reaction electrodes disposed within the reaction chamber. At least one of the reaction electrodes includes a catalyst comprising: a first component selected from protein enzymes, metabolic factors, organometallic compounds and combinations thereof; and a second component bonded to the first component, wherein the second component is selected from fluorinated sulfonic acid based polymers, polyaniline and combinations thereof; wherein the catalyst, the aqueous electrolyte and the gaseous feedstock, define a three-phase interface.

In a fourth aspect a method comprises: contacting a gaseous feedstock, an aqueous electrolyte, and a catalyst in a reaction area, the catalyst comprising a first component selected from protein enzymes, metabolic factors, organometallic compounds and combinations thereof; and a second component bonded to the first component, wherein the second component is selected from fluorinated sulfonic acid based polymers, polyaniline and combinations thereof; and activating the gaseous feedstock in an aqueous electrochemical reaction in the reaction area to yield a product.

In a fifth aspect, a catalyst comprises: a first component selected from protein enzymes, metabolic factors, organometallic compounds and combinations thereof and a second component selected from fluorinated sulfonic acid based polymers, polyaniline and combinations thereof, wherein the catalyst comprises a blend of the first component and the second component, a multi-layer film of the first component and the second component or a membrane formed from incorporating the first component into a membrane formed from the second component or a membrane formed from a blend of the first component and second component.

The above presents a simplified summary of the presently disclosed subject matter in order to provide a basic understanding of some aspects thereof. The summary is not an exhaustive overview, nor is it intended to identify key or critical elements to delineate the scope of the subject matter claimed below. Its sole purpose is to present some concepts in a simplified form as a prelude to the more detailed description set forth below.

### BRIEF DESCRIPTION OF THE DRAWINGS

The claimed subject matter may be better understood by reference to the following description taken in conjunction with the accompanying drawings, in which like reference numerals identify like elements, and in which:

FIG. 1 depicts one particular embodiment of an electrolytic cell in accordance with some aspects of the presently disclosed technique.

FIG. 2 graphically illustrates a process in accordance with other aspects of the presently disclosed technique.

FIG. 3A-FIG. 3B depict a gas diffusion electrode as may be used in some embodiments.

FIG. 4-7 depict alternative embodiments of an electrolytic cell in accordance with another aspect of the presently disclosed technique.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the subject matter claimed below will now be disclosed. In the interest of clarity, not all features of an actual implementation are described in this specification. It will be appreciated that in the development of any such actual embodiment, numerous implementation-specific decisions must he made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The presently disclosed technique provides a catalyst, methods for manufacturing same, and uses therefore. The catalyst described in further detail herein is either photocatalytic, electrocatalytic or both photocatalytic and electrocatalytic. As used herein, the term “photocatalytic” refers to the alteration of the rate of a chemical reaction by light or other electromagnetic radiation while the term “electrocatalytic” refers to a mechanism which produces a speeding up of half-cell reactions at electrode surfaces.

The catalyst generally includes a first component and a second component bonded to the first component. The first component, in various embodiments, may be selected from protein enzymes, metabolic factors or organometallic compounds. In some embodiments, the protein enzyme is a plant enzyme or a metabolic enzyme. A non-limiting plant enzyme suitable for implementation is a photosystem enzyme, including but not limited to, chlorophyll, ribulose-1,5-bisphosphate carboxylase oxygenase (RuBisCO) and derivatives thereof. Non-limiting derivatives include, by way of example, chlorophyllin and azurite. Other embodiments may use metabolic enzymes. Non-limiting, exemplary metabolic enzymes include hemoglobin, ferritin, co-enzyme Q and derivatives thereof. Still other embodiments may use metabolic factors. These may include, but are not limited to, vitamins, such as B12 and its derivatives, although other vitamins and metabolic factors may be used. And still other embodiments may use an organometallic component, such as a porphyrin complexed with a metal. The metal may include a variety of metals, such as ferromagnetic metals, including cobalt, iron, nickel and combinations thereof. One suitable porphyrin completed with a metal is cobalt tetramethoxyphenylporphyrin and derivatives thereof, although other porphyrins and other organometallic components may also be suitable.

The second component generally includes an electroconductive polymer. The electroconductive polymer may include, depending on the embodiment, a fluorinated sulfonic acid based polymer or polyalinine. One suitable fluorinated sulfonic acid based polymer is a sulfonated tetrafluoroethylene based fluoropolymer-copolymer. One particular sulfonated tetrafluoroethylene based fluoropolymer-copolymer suitable for use is sold under the trade name NAFION® by DuPont. Thus, in some embodiments, the second component may be an ion exchange resin such as NAFION®. However, other suitable electroconductive polymers may become apparent to those skilled in the art having the benefit of this disclosure and may be used in alternative embodiments.

The second component may be bonded to the first component via any method suitable for bonding such components to one another. However, such bonding process generally results in a bond that does not dissociate upon immersion or contact with water. For example, the bond may be ionic, covalent or combinations thereof. While techniques for manufacturing the catalyst are presented herein, it is understood that other techniques may be used. Similarly, while some exemplary uses are disclosed and claimed herein, the catalyst may be applied to other uses.

The catalyst may be formed in a variety of manners. For example, the catalyst may include a blend of the first component and the second component. Alternatively, the catalyst may include a multi-layer film of the first component and the second component. In one or more embodiments, the first component may be incorporated into a membrane formed from the second component. In yet another embodiment, the first component and the second component are blended and formed into a membrane.

In one or more embodiments, the catalyst includes from 20 wt. % to 80 wt. % first component and from 20 wt. % to 80 wt. % second component. For example one may use 5 grams of Chlorophyllin mixed with 20 grams of NAFION®, 10 grams of ferritin with 20 grams of NAFION® or 20 grams of B12 mixed with 5 grams of NAFION®.

In one or more embodiments, the catalyst is bound to a support material to form a supported catalyst. Typical support materials may include talc, inorganic oxides, clays and clay minerals, ion-exchanged layered components, diatomaceous earth components, zeolites or a resinous support material, such as a polyolefin, for example. Specific inorganic oxides include silica, alumina, magnesia, titania and zirconia, for example. In one or more embodiments, the support material includes a nanoparticulate material. The term “nanoparticulate materials” refers to a material having a particle size smaller than 1,000 nm. Exemplary nanoparticulate materials include, but are not limited to, a plurality of fullerene molecules (i.e., molecules composed entirely of carbon, in the form of a hollow sphere (e.g., buckyballs), ellipsoid or tube (e.g., carbon nanotubes), a plurality of quantum dots (e.g., nanoparticles of a semiconductor material, such as chalcogenides (selenides or sulfides) of metals like cadmium or zinc (CdSe or ZnS, for example)), graphite, a plurality of zeolites, or activated carbon. In addition to the non-limiting, exemplary supports listed above, any catalyst support known to those skilled in the art may be used depending upon implementation-specific design considerations. Accordingly, other embodiments may employ other supports for the catalyst.

In another aspect, the technique presents a process for forming the catalyst described previously herein. One particular embodiment of the process includes contacting the first component with the second component. Such contact may include a variety of processes, such as blending the components or forming a multi-layer film with the components, for example. One particular embodiment includes blending the first component with the second component. In one or more embodiments, the first component and the second component are contacted in a solution of alcohol and water. The solution may include from 3 wt. % to 97 wt. % alcohol and from 3 wt. % to 97 wt. % water, for example. The contact may last for a time sufficient to bond or blend the first and second component. For example, the contact may last for a time of from 30 minutes to 24 hours.

The resulting mixture may be dried to yield a crystallized catalyst. The act of drying the solution mentioned above may be performed by permitting the solution to dry by evaporation. However, some embodiments may facilitate or accelerate drying by heating the solution. However, care should be taken to avoid damaging the solution components with the heat. Thus, embodiments which include heating in the drying should heat the solution to a temperature below the breakdown or boiling temperatures of the components, i.e., the first and second component, alcohol, and water.

In one particular embodiment, the first component and the second component are blended in substantially equal molar amounts. However, this is product dependent and not all embodiments will mix in equal molar amounts. Alternative embodiments may employ different ratios for the mixture to adjust for kinetics, catalyst lifetime, and yields of products. For example, one or more embodiments may include contacting the first component and the second component in a molar ratio of from 0.8:1 to 1.2:1. Some embodiments contact and crystallize the components as described above and then add water to the crystallized catalyst to test the catalyst for water solubility. If the crystallized catalyst is still water soluble, the crystallized catalyst can be reconstituted with an alcohol/water mixture along with further first and second component and the process repeated as described above until the crystallized catalyst is no longer water soluble.

Preparing the mixture in solution may also find variation across embodiments. In one embodiment, preparing the mixture in solution includes dissolving the mixture with the alcohol and water. In another embodiment, preparing the mixture in solution includes dispersing the mixture in a colloidal suspension in the alcohol and water. Those in the art having the benefit of this disclosure may find still other alternatives for the preparation of the mixture in solution.

Some embodiments may reconstitute the crystallized polymer for reasons other than testing for water solubility. For example, in some embodiments, the crystallized polymer may be reconstituted for the purpose of fabricating it into a membrane or as otherwise described herein. In this case, the crystallized polymer may be reconstituted by, for example, adding pure alcohol or another non-water based solvent such as naphthalene or hexane. The use of such membranes is helpful in implementing some of the end uses described further below.

In a third aspect, the catalyst as described above may be implemented in an electrolytic cell. Such an electrolytic cell may comprise at least one reaction chamber and a pair of reaction electrodes. During operation, an aqueous electrolyte and a gaseous feedstock are introduced into at least one chamber, the gaseous feedstock comprising a carbon-based gas. The pair of reaction electrodes are disposed within the reaction chamber. At least one of the reaction electrodes includes the catalyst as described above adapted to catalyze reaction between the electrolyte and the gaseous feedstock.

In some embodiments, the catalyst, in conjunction with the aqueous electrolyte and the gaseous feedstock, defines a three-phase interface. However, the presently disclosed technique is not so limited. The catalyst will also operate in liquid/liquid and gas/gas reactions. With respect to gas/gas reactions, these will be between gas phase reactants.

The aqueous electrolyte may comprise any ionic substance that dissociates in aqueous solution. In various embodiments, the aqueous electrolyte is selected from potassium chloride, potassium bromide, potassium iodide, hydrogen chloride, magnesium sulfate, sodium chloride, sulfuric acid, sea salt, or brine. However, other embodiments may employ other aqueous electrolytes.

The carbon-based gas of the gaseous feedstock may comprise a non-polar gas, a carbon oxide, or a mixture of the two. Suitable non-polar gases include a hydrocarbon gas. Suitable carbon oxides include carbon monoxide, carbon dioxide, or a mixture of the two. These examples are non-limiting and other non-polar gases and carbon oxides may be used in other embodiments. In some embodiments, the gaseous feedstock comprises one or more greenhouse gases.

In a fourth aspect, an electrolytic cell in which the catalyst has been deployed as described above may be used to implement one or more methods for chain modification of hydrocarbons and organic components. The method comprises contacting a gaseous feedstock including a carbon-based gas, an aqueous electrolyte, and the catalyst in a reaction area. The carbon-based gas is then activated in an aqueous electrochemical reaction in the reaction area to yield a product.

As described above, the aqueous electrolyte may comprise any ionic substance that dissociates in aqueous solution. In various embodiments, the aqueous electrolyte is selected from potassium chloride, potassium bromide, potassium iodide, hydrogen chloride, magnesium sulfate, sodium chloride, sulfuric acid, sea salt, or brine. However, other embodiments may employ other aqueous electrolytes.

Also as described above, the carbon-based gas of the gaseous feedstock may comprise a non-polar gas, a polar gas, a carbon oxide, or a mixture of the two. Suitable non-polar gases include a hydrocarbon gas. Suitable carbon oxides include carbon monoxide, carbon dioxide, or a mixture of the two. These examples are non-limiting and other gases and inorganic gases may be used in other embodiments. In some embodiments, the gaseous feedstock comprises one or more greenhouse gases.

The apparatus and method of the third and fourth aspect above may be adapted from the apparatus and methods disclosed in, for example, International Application PCT/US13/28748 through the addition of the catalyst disclosed herein. To farther clarify how this adaptation may be, and to help illustrate the presently disclosed technique, portions of that disclosure will now be reproduced, albeit modified with the adaptation.

The presently disclosed technique is, in this particular embodiment, a process for converting carbon-based gases such as non-polar organic gases and carbon oxides to longer chained organic gases such as liquid hydrocarbons, longer chained gaseous hydrocarbons, branched-chain liquid hydrocarbons, branched-chain gaseous hydrocarbons, as well as chained and branched-chain organic components. In general, the method is for chain modification of hydrocarbons and organic components, including chain lengthening, and eventual conversion into liquids including, but not limited to, hydrocarbons, alcohols, and other organic components.

This process turns hydrocarbon gases including, but not limited to, gaseous methane, natural gas, other hydrocarbons, carbon monoxide, carbon dioxide, and/or other organic gases into C₂+ hydrocarbons, alcohols, and other organic components. One exemplary product is ethylene (C₂H₄) and alcohols. The process may also turn carbon dioxide (CO₂) into one or more of isopropyl alcohol, hydroxyl-3-methyl-2-butanone, tetrahydrofuran, toluene, 2-heptanone, 2-butoxy ethanol, 1-butoxy-2-propanol, benzaldehyde, 2-ethyl-hexanol, methyl-undecanol, methyl-octanol, 2-heptene, nonanol, diethyl-dodecanol, dimethyl-cyclooctane, dimethyl octanol, dodecanol, ethyl-1,4-dimethyl-cyclohexane, dimethyl-octanol, hexadecene, ethyl-1-propenyl ether, dimethyl-silanediol, toluene, hexanal, methyl-2-hexanone, xylene isomer, methyl-hexanone, heptanal, methyl-heptanone, benzaldehyde, octanal, 2-ethyl-hexanol, nonanal, hexene-2,5-diol, dodecanal, 3,7-dimethyl-octanol, methyl-2,2-dimethyl-1-(2-hydroxy-1-methylethyl)propyl ester propanoic acid, methyl-3-hydroxy-2,4,4-trimethylpentyl ester propanoic acid, phthalic anhydride.

This aqueous electrochemical reaction includes a reaction that proceeds at room temperature and pressure, although higher temperatures and pressures may be used. In general, temperatures may range from −10° C. to 240° C., or from −10° C. to 1000° C., and pressures may range from 0.1 ATM to 10 ATM, or from 0.1 ATM to 100 ATM. The process generates reactive activated carbon-based gases through the reaction on the reaction electrodes. On the reaction electrode, the production of activated carbon-based gases occurs.

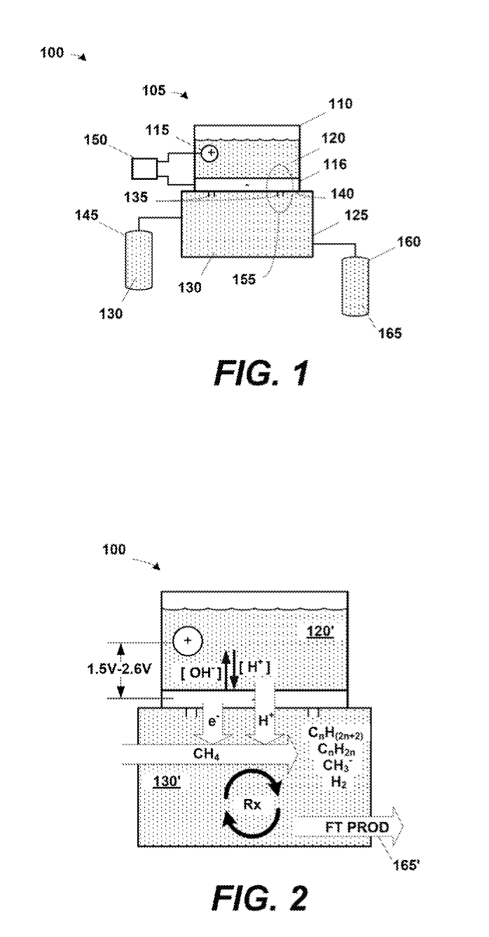

In the embodiments illustrated herein, the technique employs an electrochemical cell such as the one illustrated in FIG. 1. The electrochemical cell 100 generally comprises a reactor 105 in one chamber 110 of which are positioned two electrodes 115, 116, a cathode and an anode, separated by a liquid ion source, i.e., an electrolyte 120. Those in the art will appreciate that the identity of the electrodes 115, 116 as cathode and anode is a matter of polarity that can vary by implementation. In the illustrated embodiment, the electrode 115 is the anode and the electrode 116 is the cathode. Because of the interchangeability between electrode 115 and 116 and because in some embodiments of the design the electrodes are electrically short circuited (“shorted”), the reaction electrode is considered to be either or both of the electrode 115 and electrode 116.

There is also a second chamber 125 into which a gaseous feedstock 130 is introduced as described below. The gaseous feedstock 130 may be a carbon-based gas, for example, non-polar organic gases, carbon-based oxides, or some mixture of the two. The two chambers are joined by apertures 135 through the wall 140 separating the two chambers 110, 125. The reactor 105 may be constructed in conventional fashion except as noted herein. For example, materials selection, fabrication techniques, and assembly processes in light of the operational parameters disclosed herein will be readily ascertainable to those skilled in the art.

The electrolyte 120 will also be implementation specific depending, at least in part, on the implementation of the reaction electrode 116. Exemplary liquid ionic substances include, but are not limited to, Polar Organic Components, such as Glacial Acetic Acid, Alkali or alkaline Earth salts, such as halides, sulfates, sulfites, carbonates, nitrates, or nitrites. The electrolyte 120 may therefore be, depending upon the embodiment, magnesium sulfate (MgS), sodium chloride (NaCl), sulfuric acid (H₂SO₄), potassium chloride (KCl), hydrogen chloride (HCl), hydrogen bromide (HBr), hydrogen fluoride (HF), potassium chloride (KCl), potassium bromide (KBr), and potassium iodide (KI), or any other suitable electrolyte and acid or base known to the art.

The pH of the electrolyte 120 may range from −4 to 14 and concentrations of between 0 M and 3M inclusive may be used. Some embodiments may use water to control pH and concentration, and such water may be industrial grade water, brine, sea water, or even tap water. The liquid ion source, or electrolyte 120, may comprise essentially any liquid ionic substance.

In addition to the reactor 105, the electrochemical cell 100 includes a gas source 145 and a power source 150, and an electrolyte source 163. The gas source 145 provides the gaseous feedstock 130 while the power source 150 is powering the electrodes 115, 116 at a selected voltage sufficient to maintain the reaction at the three phase interface 155. The three phase interface 155 defines a reaction area. In one example, the reaction pressure might be, for example, 10000 pascals or from 0.1 ATM to 10 ATM, or from 0.1 ATM to 100 ATM, and the selected pressure may be, for example, between 0.01 V and 10 V.

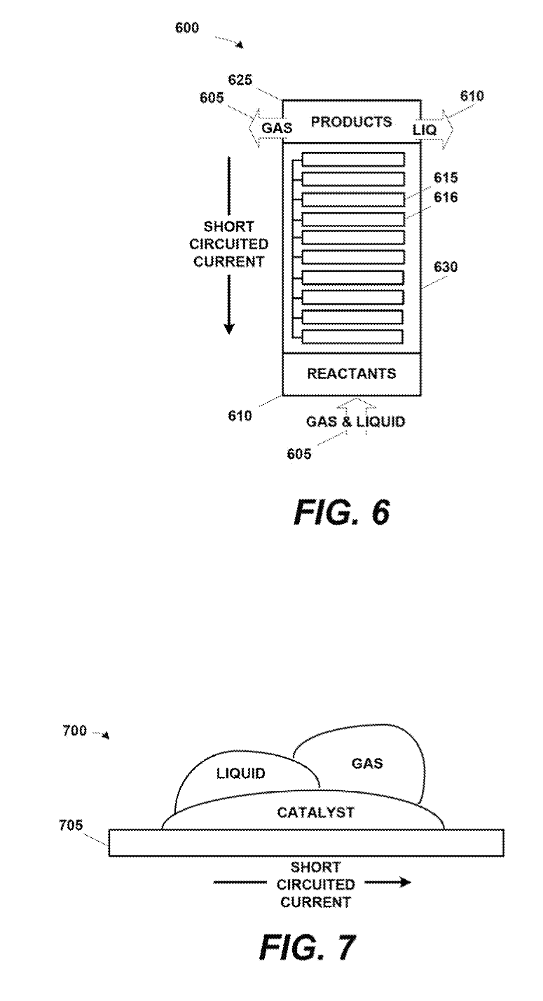

The electrolyte source 163 provides adequate levels of the electrolyte 120 to ensure proper operations. The three phases at the interface 155 are the liquid electrolyte 120, the solid catalyst of the reaction electrode 116, and the gaseous feedstock 130 as illustrated in FIG. 6. The reaction products 160 are generated in both the electrolyte 120 and in the chamber 125 and may be collected in a vessel 165 of some kind in any suitable manner known to the art. In some embodiments, the products 160 may be forwarded to yet other processes either alter collection or without ever being collected at all. In these embodiments, the products 160 may be streamed directly to downstream processes using techniques well known in the art.

Those in the art will appreciate that some implementation specific details are omitted from FIG. 1. For example, various instrumentation such as flow regulators, mass regulators, a pH regulator, and sensors for temperatures and pressures are not shown but will typically be found in most embodiments. Such instrumentation is used in conventional fashion to achieve, monitor, and maintain various operational parameters of the process. Exemplary operational parameters include, but are not limited to, pressures, temperatures, pH, and the like that will become apparent to those skilled in the art. However, this type of detail is omitted from the present disclosure because it is routine and conventional so as not to obscure the subject matter claimed below.

The reaction is conceptually illustrated in FIG. 2. In this embodiment 200, the feedstock 130′ is natural gas and the electrolyte 120′ is Sodium Chloride. Reactive hydrogen ions (H°) are fed to the natural gas stream 130′ through the electrolyte 120′ with an applied cathode potential of the molecules may also in turn react with water on the interface to form alcohols, oxygenates, and ketones. In one example of this reaction, the reaction occurs at room temperature and with an applied cathode potential of 0.01V versus SHE to 4.99V versus SHE.

The voltage level can be used to control the resulting product. A voltage of 0.01V may result in a methanol product whereas a 0.5V voltage may result in butanol as well as higher alcohols such as dodecanol. A voltage of 2 volts may results in the production of ethylene or polyvinyl chloride precursors. These specific examples may or may not he reflective of the actual product yield and are meant only to illustrate how a product produced can be altered with a change in voltage.

Returning now to FIG. 1, additional attention will now be directed to the electrochemical cell 100. As noted above, the reactor 105 can be fabricated from conventional materials using conventional fabrication techniques. Notably, the presently disclosed technique may operate at room temperatures and pressures whereas conventional processes are performed at temperatures and pressures much higher. Design considerations pertaining to temperature and pressure therefore can be relaxed relative to conventional practice. However, conventional reactor designs may nevertheless be used in some embodiments.

The presently disclosed technique admits variation in the implementation of the electrode at which the reaction occurs, hereafter referred to as the “reaction electrode”. As set forth above, either the electrode 115 or the electrode 116, or both, may be considered to be the reaction electrode depending upon the embodiment.

The counter electrode 115 and the reaction electrode 116 are disposed within a reactor 105 so that, in use, it is submerged in the electrolyte 120 and the catalyst forms one part of the three-phase interface 155. When electricity is applied to electrodes 115, 116, electrochemical reduction discussed above takes place to produce hydrocarbons and organic chemicals. The reaction electrode 116 receives the electrical power and catalyzes a reaction between the hydrogen in the electrolyte 120 and the gaseous feedstock 130.

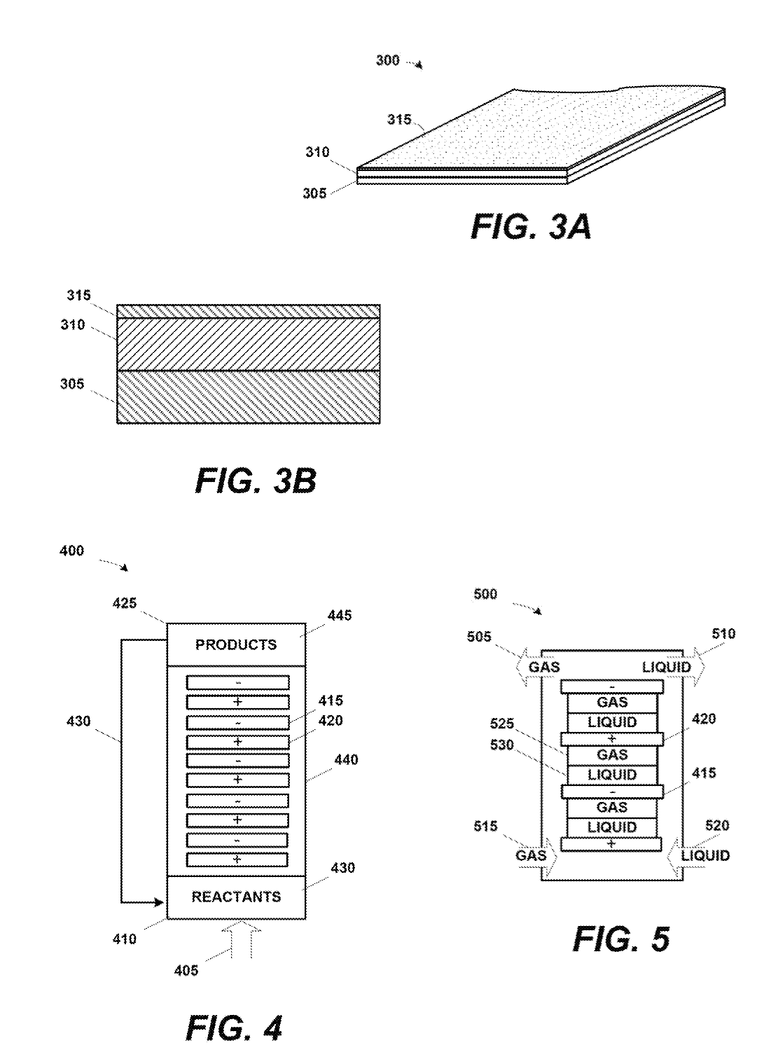

In an embodiment shown in FIG. 3A-FIG. 3B, a gas diffusion electrode 300 comprises a hydrophobic layer 305 that is porous to carbon-based gases but impermeable or nearly impermeable to aqueous electrolytes. In one embodiment of the electrode 300, a 1 mil thick advcarb carbon paper 310 treated with TEFLON® (i.e., polytetrafluoroethylene) dispersion (not separately shown) is coated with the photocatalytic and electrocatalytic membrane 315 by any means, such as painting, dipping or spray coating.

So, turning now to the process again and referring to FIG. 1, carbon-based gases or electrolyte gaseous mixture including gaseous feedstock 130 is introduced into the reaction chamber 125 of the reactor 105 under enough pressure to overcome the gravitational pressure of the column of electrolyte, which depends on the height of the electrolyte, to induce the reaction.

The method of operation generally comprises introducing the electrolyte 120 into the reaction chamber 110 into direct contact with the powered electrode surfaces 115 and 116. The gaseous feedstock 130 is then introduced into the second chamber 125 under enough pressure to overcome the gravitational pressure of the column of electrolyte, which depends on the height of the electrolyte, to induce the reaction to induce the reaction. During the reaction, the electrolyte 120 is filtered, the gaseous feedstock 130 is maintained at a selected pressure to ensure its presence at the three phase interface 155, and the product 165 is collected. Within this general context, the following examples are implemented.

By maintaining a three phase interface between the gaseous feedstock 130 and the electrolyte 120, the carbon-based gases will form organic chemicals and form a nearly complete conversion when there is continuous contact to the gaseous feedstock 130 on the three phase interfaces 155 between the liquid electrolyte 120, the solid catalyst, and the gaseous feedstock 130.

For carbon dioxide, this reaction mechanism also produces organic components such as ethers, epoxides, and C₅₊ alcohols, among other components such as ethers, epoxies and long C₅₊ hydrocarbons which have not been reported in the prior art.

The electrolyte 120 may be relatively concentrated at 0.1M-3M and may be a halide electrolyte as discussed above to increase catalyst lifetime. The higher the surface area between the reaction electrode 116 and the gaseous chamber 125 on one side and the liquid electrolyte 120 on the other side, the higher the conversion rates. Operating pressures may range from 10000 pascals or from 0.1 atm to 10 atm, though standard temperature and pressures (STP) are sufficient for the reaction.

The principles discussed above can readily be scaled up to achieve higher yield. Four such embodiments are shown in FIG. 4-FIG. 6.

For example, those in the art having the benefit of the disclosure associated with FIG. 1 will realize that the gaseous feedstock 130 and the electrolyte 120 need not necessarily be introduced into separate chambers. One such example is shown in FIG. 4. In this stacked embodiment 400, reactants 405 (e.g., gaseous feedstock and liquid electrolyte, or gaseous feedstock and a slurry of the catalyst and liquid electrolyte) enter a chamber 410 in which they are mixed, the resulting mixture 435 then entering a reaction chamber 440. A plurality of alternating anodes 420 and cathodes 415 (only one of each indicated) are positioned in the reaction chamber 440. Each of the anodes 420, cathodes 415 is a reaction electrode at which a three-phase reaction area forms as described above. The resultant product 445 is collected in the chamber 425, a portion of which is then recirculated back to the chamber 410 via the line 430.

In the stacked embodiment 500, shown in FIG. 5, the gaseous feedstock 515 and liquid electrolyte 520 are separately introduced at the bottom of the reaction chamber 525. A plurality of chambers 530 (only one indicated) are disposed between respective anodes 820 and cathodes 415. Gaseous feedstock 535 and liquid electrolyte 540 are then reacted in the chambers 530 and the resultant gas product 505 and fouled electrolyte 510 are drawn off the top.

Another stacked embodiment 600 is shown in FIG. 6. A mixture 605 of gaseous feedstock and liquid electrolyte is introduced into a chamber 610, from which it is then introduced into a reaction chamber 630 in which a plurality of alternating anodes 616 and cathodes 615 are stacked. When the anodes 616 and cathodes 615 are powered, they are shorted together. Those in the art will appreciate that, at this point, they lose their identity as a “cathode” or an “anode” because they all have the same polarity and instead all become reaction electrodes. As the mixture 605 rises in the reaction chamber 630, it forms a three-phase reaction at each reaction electrode. The gas product 605 and the fouled electrolyte 610 are drawn from the chamber 625 at the top of the embodiment 600.

In this particular embodiment, the electrodes 615, 616 are electrically short circuited within the liquid electrolyte (not shown) while maintaining a three phase interface between carbon-based gases and electrolyte at each of the electrodes 615, 616 in a mixed slurry pumped through the reactor. In this embodiment, the catalyst in powder form is mixed with the electrolyte to make a slurry. FIG. 7 depicts a portion 700 of the embodiment 600 in which the electrodes are shorted. In this drawing, only a single electrode 705 is shown but the electric potential is drawn across the electrode 705. The companion electrode (not shown) is similarly shorted.

The catalyst disclosed above, when incorporated into a suitable apparatus, can be used for a wide variety of end uses, such as to deodorize water or to produce ethylene from air for use in fruit ripening production. It can also be used to remove carbon dioxide from air while simultaneously fixing the carbon dioxide in a useful form. It also may be used to capture swamp gases, farm gases, and other dilute gases, and concentrate them in aqueous form. For example, a catalyst membrane can be constituted upon a floating porous substance, such as Teflon treated paper of any substance. One example is Teflon treated conductive carbon fiber paper. It can then be floated on the surface of a body of water and exposed to sunlight while electricity is applied. Or, alternatively, floating a painted electrode on aqueous electrolyte and then adding electricity.

The catalyst disclosed above can also be used for the conversion of greenhouse gases to aqueous sequestered chemicals such as amino acids and organic components. Such greenhouse gases may include, for example, Hydrogen Sulfide (H₂S), sulfur oxides (SOₓ), nitrogen oxides (NOₓ) (common environmental pollutants in the air) and other polar and non polar gases both organic and inorganic. For example, a catalyst membrane can be laid out on a solid surface or floated on the surface of water and exposing to sunlight, or alternatively, floating a painted electrode on aqueous electrolyte, and then adding electricity.

Note that the process catalyzes the same reaction whether through shining light on the membrane/resin or by applying electricity. Shining a light will only give a single reaction product since sunlight can only provide a fixed voltage to the membrane, while applying electricity will allow one to vary the products and reaction speeds. However, the catalyst works with both sources of energy (i.e., the catalyst is photocatalytic and electrocatalytic).

Note that not all embodiments will manifest all these characteristics and, to the extent they do, they will not necessarily manifest them to the same extent. Thus, some embodiments may omit one or more of these characteristics entirely. Furthermore, some embodiments may exhibit other characteristics in addition to, or in lieu of, those described herein.

The phrase “capable of” as used herein is a recognition of the fact that some functions described for the various parts of the disclosed apparatus are performed only when the apparatus is powered and/or in operation. Those in the art having the benefit of this disclosure will appreciate that the embodiments illustrated herein include a number of electronic or electro-mechanical parts that, to operate, require electrical power. Even when provided with power, some functions described herein only occur when in operation. Thus, at times, some embodiments of the apparatus of the invention are “capable of” performing the recited functions even when they are not actually performing them—i.e., when there is no power or when they are powered but not in operation.

The following patent, applications, and publications are hereby incorporated by reference for all purposes as if set forth verbatim herein:

U.S. Application Ser. No. 61/657,975, entitled, “Catalytic Membrane for the Continuous Air Capture and Simultaneous Fixation of C02”, filed Jun. 11, 2012, in the name of file inventors Tara Cronin and Ed Chen and commonly assigned herewith.

U.S. Application Ser. No. 61/698,608, entitled, “Protein and Enzyme Cofactors Immobilized Nafion or Other Electroconducting Polymer Co-membrane”, filed Sep. 8, 2012, in the name of the inventors Tara Cronin and Ed Chen and commonly assigned herewith.

U.S. application Ser. No. 13/783,102, entitled, “Method and Apparatus for an Electrolytic Cell including a Three-Phase Interface to React Carbon-Based Cases in an Aqueous Electrolyte”, filed Mar. 1, 2013, in the name of the inventor Ed Chen and commonly assigned herewith.

International Application Serial No. PCT/US 13/28748, entitled, “Method and Apparatus for an Electrolytic Cell Including a Three-Phase Interface to React Carbon-Based Gases in an Aqueous Electrolyte”, filed Mar. 1, 2013, in the name of the inventor Ed Chen and commonly assigned herewith.

U.S. application Ser. No. 13/782,936, entitled, “Chain Modification of Gaseous Methane Using Aqueous Electrochemical Activation at a Three-Phase Interface”, filed Mar.1, 2013, in the name of the inventor Ed Chen and commonly assigned herewith.

International Application Serial No. PCT/US13/28728, entitled, “Chain Modification of Gaseous Methane Using Aqueous Electrochemical Activation at a Three-Phase interface”, filed Mar. 1, 2013, in the name of the inventor Ed Chen and commonly assigned herewith.

To the extent that any patent, patent application, or other reference incorporated herein by reference conflicts with the present disclosure set forth herein, the present disclosure controls.

### EXAMPLES

### Example 1

A number of samples were analyzed with an Extech infrared CO₂ monitor to determine the effect of the contact of various catalyst samples upon a gaseous feedstock comprising CO₂. The samples included chlorophyll in (15 by weight %) mixed with a NAFION® dispersion with 85% by weight. The resulting mixture was diluted in a 70% ethanol/30% water mixture, which was stirred until the Chlorophyllin was fully dissolved. This mixture was allowed to dry in open air all water and alcohol was evaporated. The resulting solid crystal compound of Chlorophyllin bounded membrane was then reconstituted by adding a 97% isopropyl alcohol and 3% water mixture into a paint, and painted onto the surface of a porous conducting carbon paper. This paper was placed on the surface of a container of 2 Molar Sodium Sulfite aqueous electrolyte and connected to a power source set to 0.5 volts with 30 square centimeters of surface area exposed to the rest of the enclosed atmosphere. The samples were exposed to CO₂ in a 16 liter closed container with 30 square cm of contact area between the carbon paper painted with the catalytic membrane and the power source was switched on. Upon powering of the electrode floating on the surface of the water and contacting the enclosed air, the level of CO2 was monitored and recorded in Table 1 below. Such contact occurred at ambient room temperatures and pressures. It was observed that after only 8 minutes, the resultant level of CO2 had been lowered to 350 ppm (see, Table 1), the level determined as the maximum, which would prevent catastrophic climate change.

TABLE 1

| Minutes | CO₂ ppm |
|---|---|
| 1 | 750 |
| 2 | 700 |
| 3 | 600 |
| 4 | 520 |
| 5 | 450 |
| 6 | 400 |
| 7 | 400 |
| 8 | 350 |
| 9 | 300 |
| 10 | 250 |
| 11 | 200 |
| 12 | 160 |
| 13 | 128 |
| 14 | 102 |
| 15 | 80 |
| 16 | 64 |
| 17 | 51 |
| 18 | 41 |
| 19 | 33 |
| 20 | 27 |
| 21 | 22 |
| 22 | 18 |

### Example 2

A number of samples were analyzed by Gas Chromotography/Mass Spectroscopy to determine the effect of the contact of catalyst samples upon a gaseous feedstock over time. The gaseous feedstock is methane, while the catalyst is formed from B12 impregnated within a NAFION® membrane in approximately equal molar amounts. This formed a catalyst was supported on a support material comprising 50% equal mixture by weight magnesium oxide, graphite and copper nanoparticles and 50% by weight of the B-12 NAFION membrane that was painted onto a porous conductive carbon paper. The samples were exposed to gaseous feedstock at various electrical pulse levels for a varied period of time to determine the resultant products formed (shown in Table 2) from the contact of the gaseous feedstock with the catalyst. Such contact occurred at ambient room temperature and pressure. It was observed that the reaction produced longer chained molecules than that of the gaseous feedstock, in this example, methane. It was further observed that the length of the retention time could be tailored to form the length of the chain and position of substituents on the product. In the first set of experiments a one second pulse of 2 Volts was used with no reverse pulse over a period of 1 hour as methane was fed to the interface between the painted carbon paper electrode and the liquid electrolyte consisting of 3 molar KCl. In the second set of experiments, 2 millisecond pulses were used with a reverse pulse of 100 microseconds. In the third experiment, no reverse pulse was used and a continuous 2 volt potential was applied to the electrode. In the final set of experiments, labeled FT Cold Trap, the methane gas with a 1 second pulse followed by a 2 ms reverse pulse was passed over a cold trap to gather condensate.

TABLE 2

| ELECTRICAL PULSE | RETENTION TIME (MIN) | BEST SPECTRAL MATCH |
|---|---|---|
| 1 SECOND | 4.001 | ACETYL CHLORIDE |
| 1 SECOND | 5.072 | ACETONE |
| 1 SECOND | 5.147 | ISOPROPYL ALCOHOL |
| 1 SECOND | 6.204 | 1-PROPANOL |
| 1 SECOND | 6.761 | 2-BUTANONE |
| 1 SECOND | 7.519 | ACETIC ACID |
| 1 SECOND | 15.287 | DIMETHYL-BENZENEMETHANOL |
| 2 MS | 4.007 | METHYL HYDROGEN DISULFIDE |
| 2 MS | 5.185 | ISOPROPYL ALCOHOL |
| 2 MS | 8.660 | 2-(METHYLTHIO)-ETHANAMINE |
| 2 MS | 9.504 | UNIDENTIFIED |
| NONE | 3.925 | ACETYL CHLORIDE |
| NONE | 5.153 | ISOPROPYL ALCOHOL |
| NONE | 5.540 | ACETALDOXIME |
| NONE | 6.764 | 2-BUTANONE |
| NONE | 6.885 | 2-BUTANOL |
| 1 S Pulse, 2 ms Reverse | 3.821 | ACETALDEHYDE |
| 1 S Pulse, 2 ms Reverse | 4.657 | ETHANOL |
| 1 S Pulse, 2 ms Reverse | 5.080 | ACETONE |
| 1 S Pulse, 2 ms Reverse | 5.160 | ISOPROPYL ALCOHOL |
| 1 S Pulse, 2 ms Reverse | 5.382 | ACETIC ACID METHYL ESTER |
| 1 S Pulse, 2 ms Reverse | 6.184 | 1-PROPANOL |
| 1 S Pulse, 2 ms Reverse | 6.768 | 2-BUTANONE |
| 1 S Pulse, 2 ms Reverse | 6.872 | 2-BUTANOL |
| 1 S Pulse, 2 ms Reverse | .440 | 2-METHYL-1-PROPANOL |
| 1 S Pulse, 2 ms Reverse | 7.526 | ACETIC ACID |
| 1 S Pulse, 2 ms Reverse | 8.138 | 1-BUTANOL |
| 1 S Pulse, 2 ms Reverse | 9.678 | 3-METHYL-1-BUTANOL |
| 1 S Pulse, 2 ms Reverse | 10.307 | 1-PENTANOL |
| 1 S Pulse, 2 ms Reverse | 11.605 | 4-METHYL-1-PENTANOL |
| 1 S Pulse, 2 ms Reverse | 11.779 | 1-HEXANOL |
| 1 S Pulse, 2 ms Reverse | 12.108 | 1-HEPTANOL |
| 1 S Pulse, 2 ms Reverse | 13.562 | 1-(2-METHOXY-1-METHYLETHOXY)-2- |
| | | PROPANOL |
| 1 S Pulse, 2 ms Reverse | 13.981 | 1-(2-METHOXY-1-METHYLETHOXY)-2- |
| | | PROPANOL |
| 1 S Pulse, 2 ms Reverse | 14.019 | 1-(2-METHOXYPROPOXY)-2-PROPANOL |
| 1 S Pulse, 2 ms Reverse | 14.189 | 1-OCTANOL |

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A catalyst comprising:
a first component selected from protein enzymes, metabolic factors, organometallic compounds and combinations thereof; and
a second component bonded to the first component, wherein the second component is selected from fluorinated sulfonic acid based polymers, polyaniline and combinations thereof.

2. The catalyst of claim 1, wherein the catalyst is photocatalytic and electrocatalytic.

3. The catalyst of claim 1, wherein the second component is bonded to the first component ionically, covalently or a combination thereof.

4. The catalyst of claim 1, wherein the protein enzymes are selected from chlorophyll, ribulose-1,5-bisphosphate carboxylase oxygenase (RuBisCO), chlorophyllin, azurite, hemoglobin, ferritin, co-enzyme Q, derivatives thereof and combinations thereof.

5. The catalyst of claim 1, wherein the metabolic factor is selected from vitamins.

6. The catalyst of claim 1, wherein the metabolic factor is vitamin B12.

7. The catalyst of claim 1, wherein the organometallic compound comprises porphyrin complexed with a metal.

8. The catalyst of claim 7, wherein the metal is a ferromagnetic metal.

9. The catalyst of claim 1, wherein the organometallic compound comprises cobalt tetramethoxyphenylporphyrin or derivatives thereof.

10. The catalyst of claim 1, wherein the fluorinated sulfonic acid based polymer comprises sulfonated tetrafluoroethylene based fluoropolymer-copolymer.

11. The catalyst of claim 1, wherein the first component is selected from chlorophyll derivatives, hemoglobin, photosystem enzymes and combinations thereof.

12. The catalyst of claim 1 comprising a film of the first component and the second component.

13. The catalyst of claim 1, wherein the first component is incorporated into a membrane formed of the second component.

14. The catalyst of claim 1 further comprising a support material

15. The catalyst of claim 14, wherein the support material comprises a nanoparticle mixture.

16. The catalyst of claim 14, wherein the support material is selected from a plurality of fullerene molecules, a plurality of quantum dots, graphite, a plurality of zeolites, and activated carbon.

17. The catalyst of claim 1, wherein the catalyst is selective to carbon based gases.

18. The catalyst of claim 1 comprising from about 40 wt. % to about 60 wt. % first component and from about 40 wt. % to about 60 wt. % second component.

19. A method of forming a catalyst comprising:
contacting a first component selected from selected from protein enzymes, metabolic factors, organometallic compounds and combinations thereof with a second component selected from fluorinated sulfonic acid based polymers, polyaniline and combinations thereof.

21. The method of claim 19, wherein the contacting is selected from blending, incorporating the first component into a membrane formed from the second component and forming a multi-layer film.

22. The method of claim 19, wherein the first component contacts the second component in essentially equal molar concentrations.

23. The method of claim 19, wherein the first component contacts the second component in a molar ratio of from 0.8:1.2 to 1.2:0.8.

24. The method of claim 19, wherein the contacting occurs in the presence of a solution of alcohol and water.

25. The method of claim 24 further comprising drying to solution to yield a crystallized catalyst.

26. The method of claim 25, wherein drying the solution comprises heating the solution to a temperature fellow the breakdown or boiling temperatures of the first component, the second component, alcohol or water.

27. The method of claim 24, wherein the contacting comprises dissolving the first and second components in the solution.

28. The method of claim 24, wherein the contacting comprises dispersing the first and second components in a colloidal suspension in the solution.

29. The method of claim 19 further comprising forming a membrane from the catalyst.

30. An electrolytic cell, comprising:
at least one reaction chamber into which, during operation, an aqueous electrolyte and a gaseous feedstock are introduced, wherein the gaseous feedstock comprises a carbon-based gas; and
a pair of reaction electrodes disposed within the reaction chamber, at least one of the reaction electrodes including a catalyst comprising:
a first component selected from protein enzymes, metabolic factors, organometallic compounds and combinations thereof; and
a second component bonded to the first component, wherein the second component is selected from fluorinated sulfonic acid based polymers, polyaniline and combinations thereof;
wherein the catalyst, the aqueous electrolyte and the gaseous feedstock, define a three-phase interface.

31. The electrolytic cell of claim 30, wherein the aqueous electrolyte is selected from potassium chloride, potassium bromide, potassium iodide, or hydrogen chloride.

32. The electrolytic cell of claim 30, wherein the carbon-based gas comprises a non-polar gas, a carbon oxide, or a mixture of the two.

33. The electrolytic cell of claim 30, wherein the non-polar gases include a hydrocarbon gas.

34. The electrolytic cell of claim 30, wherein the carbon oxide includes carbon monoxide, carbon dioxide, or a mixture of the two.

35. The electrolytic cell of claim 30, wherein the gaseous feedstock is a greenhouse gas.

36. A method comprising:
contacting a gaseous feedstock, an aqueous electrolyte, and a catalyst in a reaction area, the catalyst comprising a first component selected from protein enzymes, metabolic factors, organometallic compounds and combinations thereof; and
a second component bonded to the first component, wherein the second component is selected from fluorinated sulfonic acid based polymers, polyaniline and combinations thereof; and
activating the gaseous feedstock in an aqueous electrochemical reaction in the reaction area to yield a product.

37. The method of claim 36, wherein the product comprises a chain modified hydrocarbon or organic component.

38. The method of claim 36, wherein the carbon-based gas comprises a non-polar gas, a carbon oxide, or a mixture thereof.

39. The method of claim 36, wherein the non-polar gases include a hydrocarbon gas.

40. The method of claim 36, wherein the aqueous electrolyte is selected from magnesium sulfate, sodium chloride, sulfuric acid, potassium chloride, hydrogen chloride, potassium, chloride, potassium bromide, potassium iodide, sea salt, and brine.

41. The method of claim 36, wherein the method is a continuous gas capture process and further comprises sequestering the product.

42. The method of claim 36, wherein the gaseous feedstock is a dilute, atmospheric greenhouse gas.

43. The method of claim 36, wherein the product comprises amino acids, organic components, or a combination thereof.

44. A catalyst comprising:
a first component selected from protein enzymes, metabolic factors, organometallic compounds and combinations thereof; and
a second component selected from fluorinated sulfonic acid based polymers, polyaniline and combinations thereof,
wherein the catalyst comprises a blend of the first component and the second component, a multi-layer film of the first component and the second component or a membrane formed from incorporating the first component into a membrane formed from the second component or a membrane formed from a blend of the first component and second component.
